(19) United States
(12) Patent Application Publication
(10) Pub. No.: US 2007/0066128 A1
(43) Pub. Date: Mar. 22, 2007

(54) Serial AT attachment interface

(76) Inventors: Tsung-Chi Wu, Hsinchu City (TW); Peng-Fei Lin, Hsinchu City (TW)

Correspondence Address: LIN & ASSOCIATES INTELLECTUAL PROPERTY, P.O. BOX 2339, SARATOGA, CA, 95070-0339, US

(21) Appl. No.: 11/231,378

(22) Filed: Sep. 21, 2005

(51) Int. Cl. H01R 12/24

(52) U.S. Cl. 439/499

(57) ABSTRACT

An improved SATA interface is provided by integrating a power line into a standard ATA interface. One end of the power line is connected to the power pin of the PC and the other end is connected to the power pin of the device, so that the device can draw power from the PC. This saves the power supply design in the external devices, simplifies the device wiring and reduces the manufacture cost.

### FIELD OF THE INVENTION

The present invention generally relates to a serial AT attachment (SATA) interface, and more specifically to a SATA interface integrating power line and standard ATA interface, and remaining compatible with the original SATA standard interface.

### BACKGROUND OF THE INVENTION

Since the emergency of IBM's PC/AT, PC or laptop computer has become ubiquitous. The AT attachment (ATA) or the ATA packet interface (ATAPI) between AT and devices has become the most popular device interface. For example, more than 90% of the harddisks use ATA interface, and the remaining uses SCSI interface. In addition, the majority of CD-ROM uses ATAPI, and the majority of PCMCIA and CFA mass storage devices also use ATA or ATAPI interface.

Serial ATA (SATA) is the newest version of the ATA interface. SATA defines several types for interface pins, including single lane and multi-lane interface pins. The multi-lane interface pins further include 2-lane and 4-lane interface pins.

FIG. 1 shows a schematic view of a standard SATA single lane interface pins. As shown in FIG. 1, a standard SATA interface 101 includes a PC connector 1011, a ATA cable 1012 and a device connector 1013. The two ends of ATA cable 1012 are connected to PC connector 1011 and device connector 1013, respectively. ATA cable 1012, as shown in FIG. 1, includes 7 signal lines 101, but no power line for external device is provided. The SATA interface is mostly used in harddisks, including a single harddisk or a harddisk array.

Because the original SATA interface pins do not include power line for external device, the external devices using SATA interface must provide own power line. If the power line is integrated into the SATA interface pins, it is possible to provide power to the external devices from the power supply of the PC. This not only saves the power supply of the external devices, but also simplifies the connection design.

### SUMMARY OF THE INVENTION

The present invention has been made to overcome the above-mentioned drawback of original SATA interface. The primary object of the present invention is to provide an improved SATA interface having power line integrated with the standard SATA interface to simplify the device design and reduce the manufacture cost, while remaining compatible to the original SATA interface.

There are three embodiments of the present invention. The first embodiment is the integration of power line and the single-lane SATA interface pins. The second embodiment is the integration of power line with the 2-lane SATA interface pins. The third embodiment is the integration of the power line and the 4-lane SATA interface pins.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a standard SATA single lane interface pins;

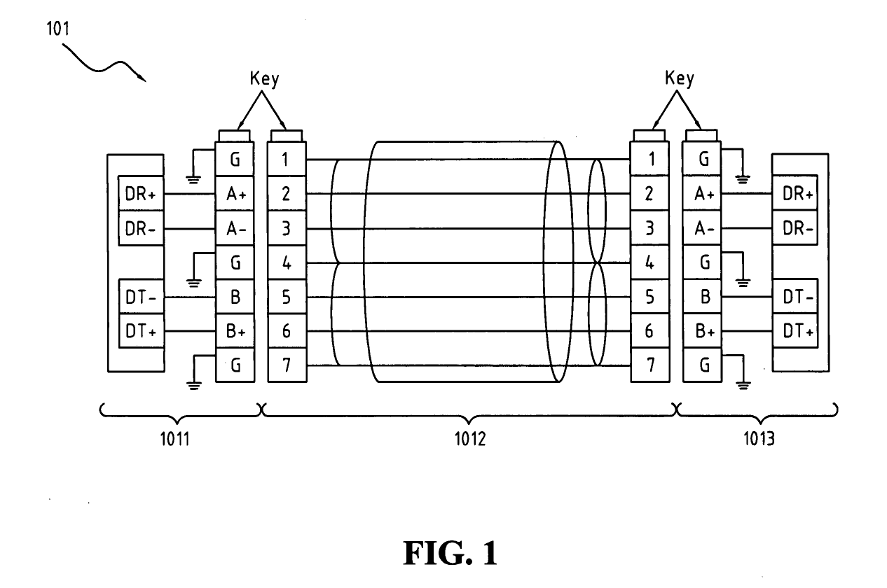

FIG. 2 shows a schematic view of the first embodiment according to the present invention;

FIG. 3 shows a schematic view of the second embodiment according to the present invention; and

FIG. 4 shows a schematic view of the third embodiment according to the present invention.

### DETAILED DESCRIPTION OF THE PREFERRED EMBODIMENTS

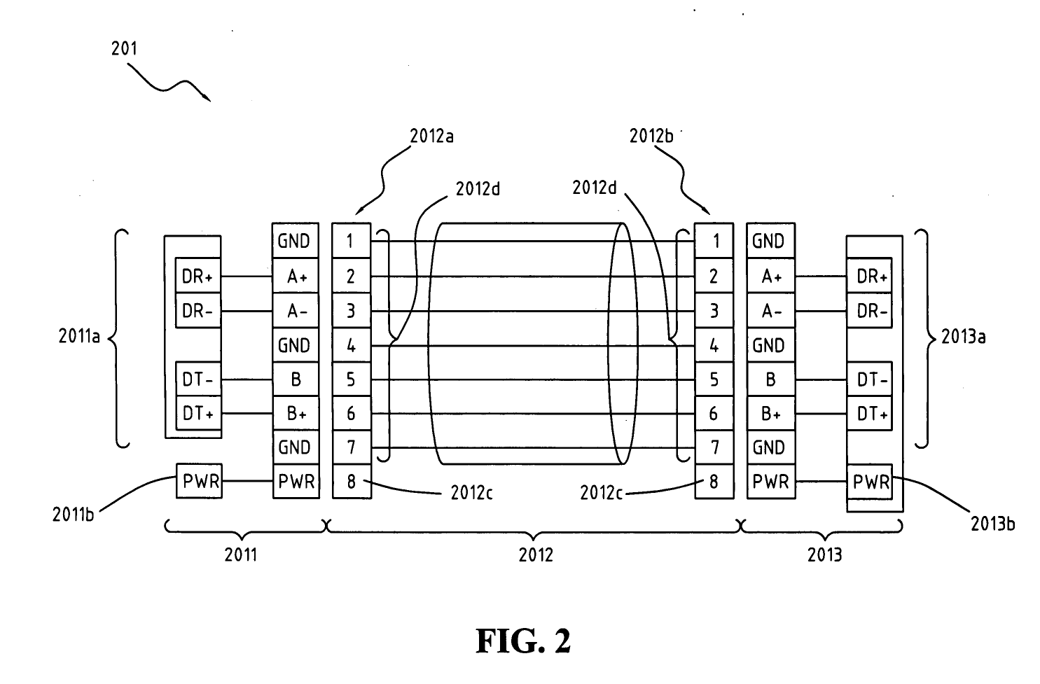

FIG. 2 shows a schematic view of the first embodiment according to the present invention, the integration of a power line into a standard SATA single lane interface.

As shown in FIG. 2, a SATA interface 201 of the present invention includes a first end (i.e., PC end) connector 2011, a second end (i.e., device end) connector 2013, and a cable 2012. First end connector 2011 integrates a first power pin 2011b and a PC end connector 2011a. Second end connector 2013 integrated a second power pin 2013b and a device end connector 2013a. Cable 2012 includes a first end 2012a and a second end 2012b, connected to first end connector 2011 and second end connector 2013, respectively. Cable 2012 integrates a power line 2012c with an ATA cable 2012d. ATA cable 2012d includes the 7 pins of a standard SATA interface. Power line 2012c includes two ends, a power pin 2011b connected to PC end 2011 and a power pin 2013b connected to device end 2013.

Device end 2013 is an external storage device or a portable storage device, such as harddisk, flash memory stick, VCD-ROM, VCD-RW, DVD-ROM, DVD-RW, and so on.

The feature of the first embodiment of the present invention shown in FIG. 2 enables the drawing of power supply from PC to the external devices.

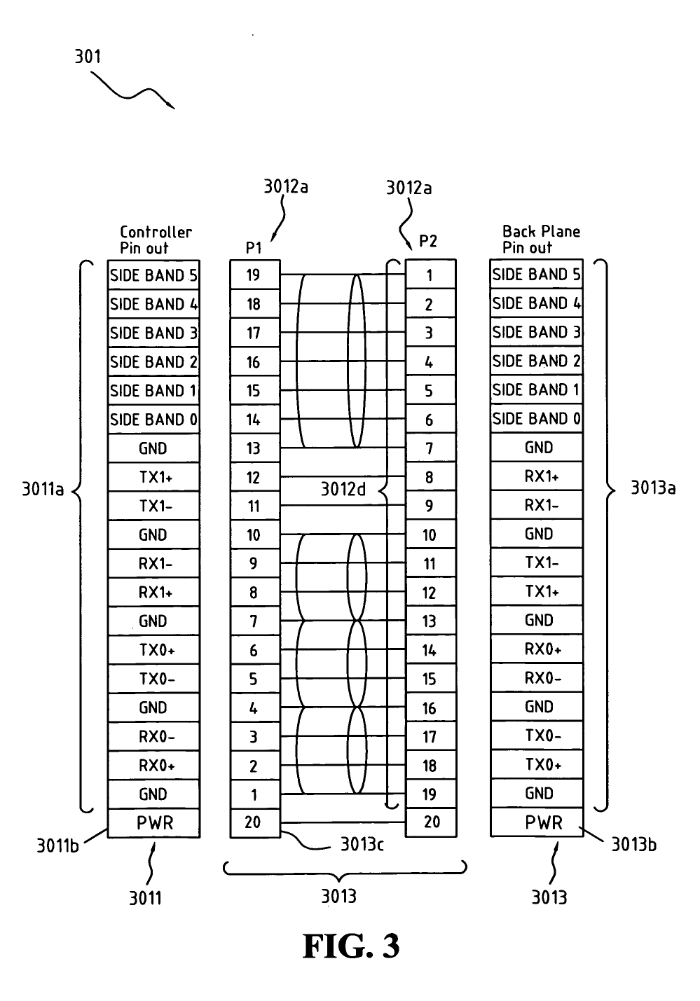

FIG. 3 shows a schematic view of the second embodiment of the present invention. As shown in FIG. 3, a power line is integrated into a 2-lane SATA interface. A SATA interface 301 of the present invention includes a first end connector 3011 integrating a first power pin 3011b and a PC end connector 3011a, a second end connector 3013 integrating a second power pin 3013b and a device end connector 3013a, and a cable 3012, including a first end 3012a and a second end 3012b, connected to first end connector 3011 and second end connector 3013, respectively. Cable 3012 integrates a power line 3012c with an ATA cable 3012d.

It is worth noticing that ATA cable 3012d includes 19 pins of a standard 2-lane SATA. Similarly, the two ends of power line 3012c are the power pins 3011b, 3011a of the PC end and device end, respectively. The external device can draw power from the two pins.

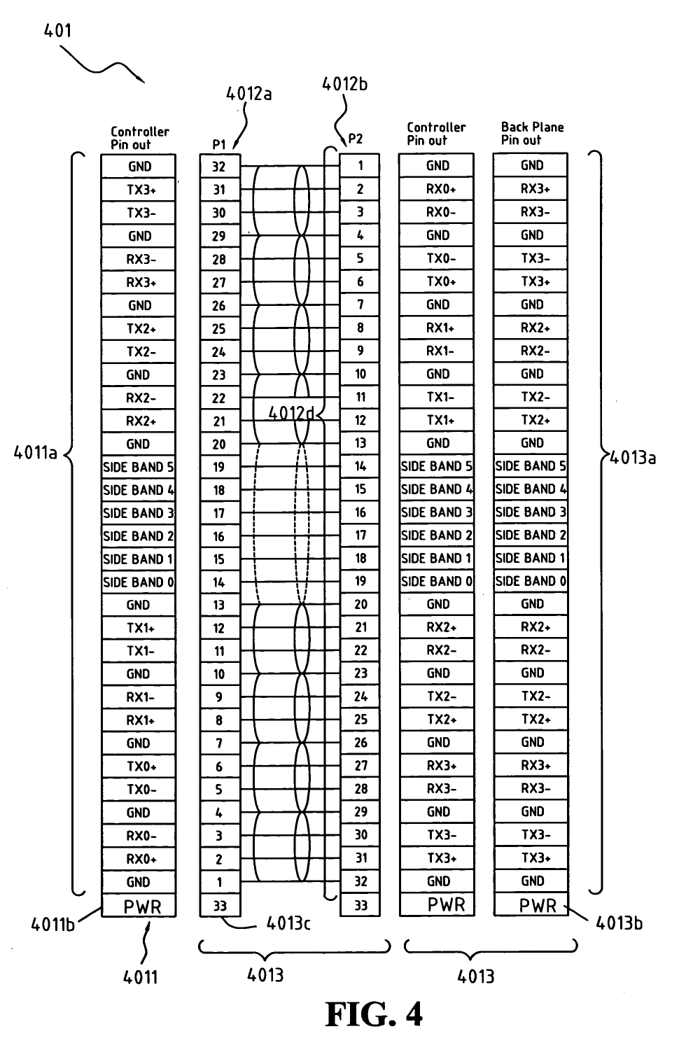

FIG. 4 shows a schematic view of the third embodiment of the present invention. As shown in FIG. 4, a power line is integrated into a 4-lane SATA interface. A SATA interface 401 of the present invention includes a first end connector 4011 integrating a first power pin 4011b and a PC end connector 4011a, a second end connector 4013 integrating a second power pin 4013b and a device end connector 4013a, and a cable 4012, including a first end 4012a and a second end 4012b, connected to first end connector 4011 and second end connector 4013, respectively. Cable 4012 integrates a power line 4012c with an ATA cable 4012d.

It is worth noticing that ATA cable 4012d includes 32 pins of a standard 4-lane SATA. Similarly, the two ends of power line 4012c are the power pins 4011b, 4011a of the PC end and device end, respectively. The external device can draw power from the two pins.

In summary, the SATA interface of the present invention integrates the separate power line and the signal lines in an original SATA interface into a single cable, while the present invention remains compatible to the original SATA interface. In comparison with the original SATA interface, the present invention simplifies the design and provides more convenience for use.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A serial ATA attachment (SATA) interface, integrating a power line into a standard SATA interface, said standard SATA interface comprising a PC end connector, an ATA cable and a device end connector, said ATA cable connecting to said PC end connector and said device connector, respectively, said SATA interface comprising:
a first end-connector, integrating a first power pin and said PC end connector;
a second end connector, integrating a second power pin and said device end connector; and
a cable, having a first end and a second end connected to said first end connector and said second end connector, respectively, said cable integrating a power line and said ATA cable.

2. The interface as claimed in claim 1, wherein said power line has two ends, with the first end as the power pin of said PC end, and the second as the power pin of said device end.

3. The interface as claimed in claim 1, wherein said device end is an external storage device.

4. The interface as claimed in claim 1, wherein said device end is a portable storage device.

5. The interface as claimed in claim 1, wherein said standard SATA cable uses a single lane pin configuration.

6. The interface as claimed in claim 1, wherein said standard SATA cable uses a 2-lane pin configuration.

7. The interface as claimed in claim 1, wherein said standard SATA cable uses a 4-lane pin configuration.
